(19) United States
(12) Patent Application Publication
(10) Pub. No.: US 2026/0131287 A1
(43) Pub. Date: May 14, 2026

(54) Vibrating Filtration Device

(71) Applicant: SANI Membranes A/S, Farum (DK)

(72) Inventor: Henrik Hjelmsmark, Farum (DK)

(21) Appl. No.: 19/118,939

(22) PCT Filed: Oct. 12, 2023
(86) PCT No.: PCT/EP2023/078417

§ 371 Date: Apr. 7, 2025

(30) Foreign Application Priority Data
Oct. 14, 2022 (EP) 22201641.2

(51) Int. Cl. B01D 63/16; B01D 61/18; B01D 61/20; B01D 63/06; B01D 63/08

(52) U.S. Cl. CPC B01D 63/16; B01D 61/18; B01D 61/20; B01D 63/063; B01D 63/0822; B01D 63/087; B01D 2315/04; B01D 2321/2058

(57) ABSTRACT

A device includes a module including: a volume chamber including an inlet and a retentate outlet; a drainage chamber connected to the volume chamber and including an outlet; a membrane separating the volume chamber from the drainage chamber allowing permeate to pass while retaining retentate; a wall that is impermeable to the liquid to be filtered on one side, and in contact with the environment on the other side, thereby separating the liquid from the environment; where the volume chamber and the membrane are configured to allow the liquid in the volume chamber to transit the membrane when vibrated; where the volume chamber and the wall are configured to extend or contract the wall determined by the pressure of the liquid on wall applied when the module is vibrated; and where the device further includes a motor having a receptacle for the module and being configured for vibrating the module.

### CROSS REFERENCE TO RELATED APPLICATIONS

This application is a § 371 national stage of international application no. PCT/EP2023/078417, filed on Oct. 12, 2023, which claims priority to European application no. 22201641.2, filed Oct. 14, 2022, the entire contents of both of which are hereby incorporated by reference herein.

### FIELD

The present disclosure describes a filtration device configured for continuous vibration and low-pressure filtration. Also described herein are methods for filtering a liquid using the filtration device and thereby separating components of the liquid into a permeate while retaining other components in a retentate.

### BACKGROUND

Vibrating filtration devices are known from WO2018145714, WO2022157133 or WO2022171615 all to Sani Membranes. All of these devices rely, however, on dampening the vibrating motion of the liquid to be filtered by use of gas filled cushions. Such vibration filter devices are technically complicated to produce as they require the gas filled cushions to be not only tightly sealed against the liquid to be filtered, but it must also tightly seal off the gas inside the cushion.

### SUMMARY

Over this background art it is an object of this disclosure to describe a filtration device having a simplified module construction with optimized free flow filtering capacity and being capable of maintaining a high flux at low pressure in a vibration driven filtration process. The present inventor have now found that, particularly for filtration under lower pressures in the liquid to be filtered, the gas filled cushions of the vibration filter devices of the art can be replaced by an elastic wall element separating the liquid to be filtered from the external atmospheric environment, wherein the elastic wall element is capable of extending and contracting thereby withstanding the over pressure and under pressure in the liquid to be filtered caused by the vibrating motion.

Accordingly, in a first aspect a filtration device (1) is described herein for low pressure vibration filtration of a liquid comprising one or more filter modules (2), each filter module comprising;

a volume chamber (3) comprising a feed inlet (5) for a liquid to be filtered and a retentate outlet (7);

a drainage chamber (4) fluidly connected to the volume chamber (3) and comprising a permeate outlet (6);

a semipermeable membrane (8) separating the volume chamber from the drainage chamber allowing one or more components of the liquid (permeate) to pass from the volume chamber to the drainage chamber while retaining one or more components of the liquid (retentate) in the volume chamber;

one or more flexible wall elements, (9), positioned distally in at least one end of the volume chamber, wherein the flexible wall element is impermeable to, but in contact with the liquid to be filtered on one side, and in contact with the external atmospheric environment on the other side, thereby separating the liquid from the external atmospheric environment; and wherein the volume chamber and the semipermeable membrane are configured to allow the liquid in the volume chamber to move across the surface of the semipermeable membrane when the filter module is subjected to a vibrating motion; wherein the volume chamber and the flexible wall element are configured to extend or contract the flexible wall element determined by the pressure of the liquid on flexible wall element applied when the filter module is subjected to a vibrating motion.

In a further aspect, a method is described herein for filtering a liquid and separating one or more components of a liquid (permeate) from one or more other components of the liquid (retentate) comprising feeding the liquid to the filtration device of this disclosure and applying vibrational motion to the filter module(s) comprised in the filtration device and collecting the separated retentate and permeate.

The inertia of the retentate will counter the move of the filter module during vibrating motion creating a washing of the semipermeable membrane surface by the retentate and this will keep the semipermeable membrane clean and thereby secure continuous fouling free filtration using a minimum of energy.

The filtration device of the invention is useful for operations, such as fine filtration, microfiltration and ultrafiltration of liquids using a semipermeable membrane, where the membrane is typically subjected to a tangential flow of feed fluid. The filtration device is useful in operations where a robust and sanitary, fouling preventing continuous filtration is desirable, and the filtration device is capable of being configured to filtering operations of a wide range of fluid volumes, such as volumes as small as about 100 mL and being scalable to filter larger volumes, such as 100 m3.

### BRIEF DESCRIPTION OF THE FIGURES

The figures included herein are illustrative and simplified for clarity, and they merely show details which are essential to the understanding of the invention, while other details may have been left out. Throughout the specification, claims and drawings the same reference numerals are used for identical or corresponding parts. In the figures and drawing include herein:

FIG. 1 shows a cross section of a first example of a flat filter module made of two fitting half plates.

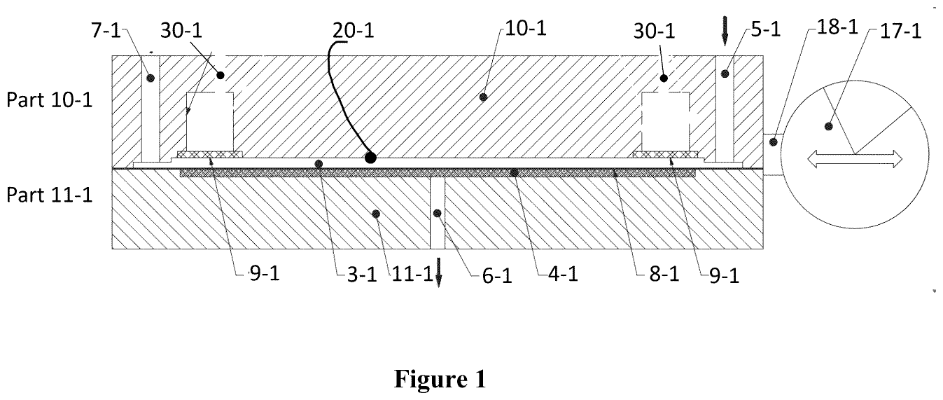

FIG. 2 shows a top side view of the first filter module example.

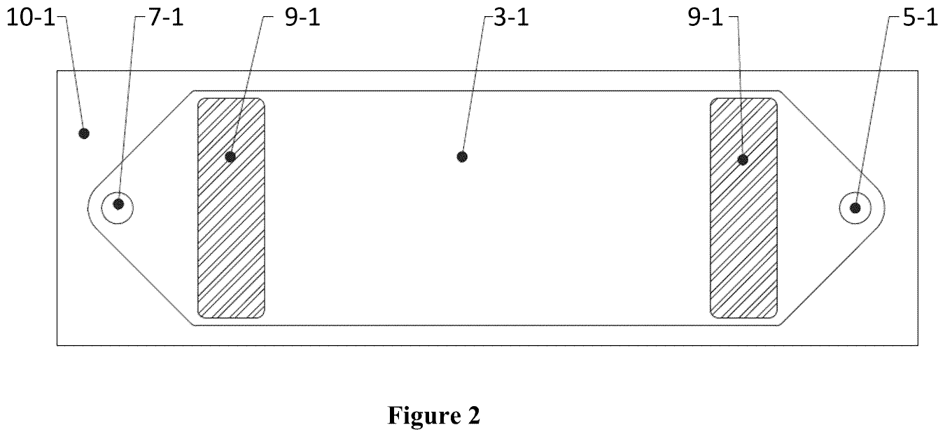

FIG. 3 shows a bottom side view of the first filter module example.

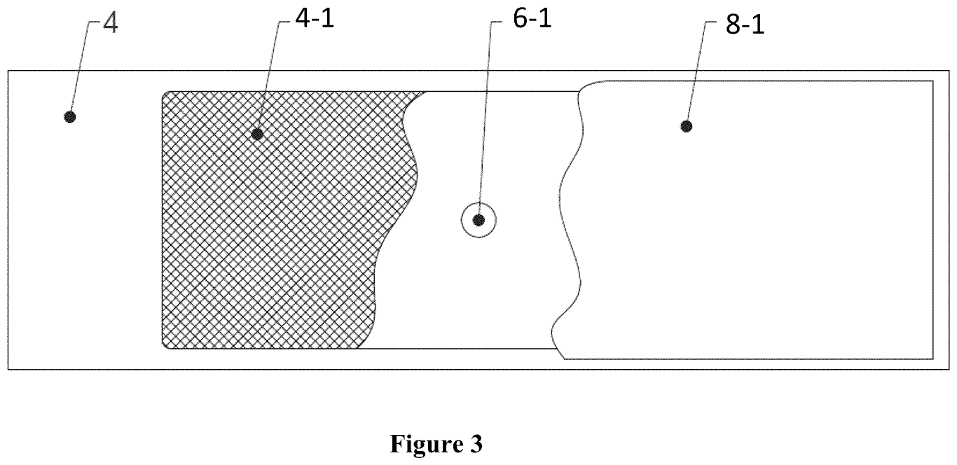

FIG. 4 shows a cross section of a second example of a flat filter module made of two fitting half plates.

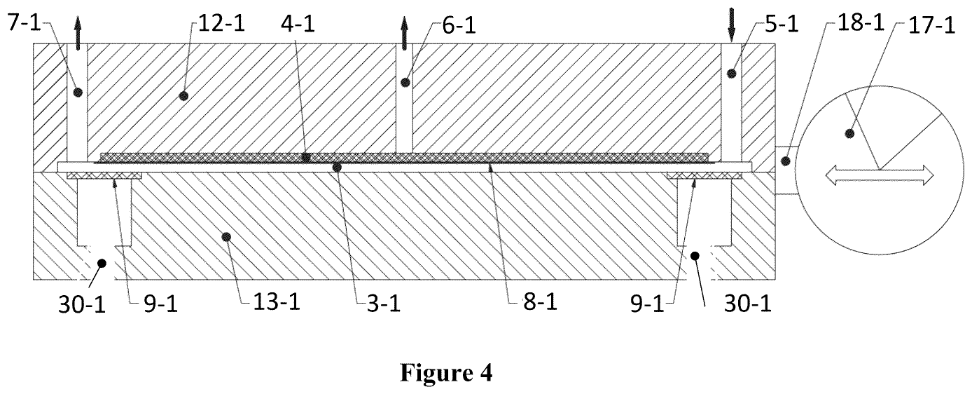

FIG. 5 shows a cross section of a third example of a flat filter module made of three fitting plates.

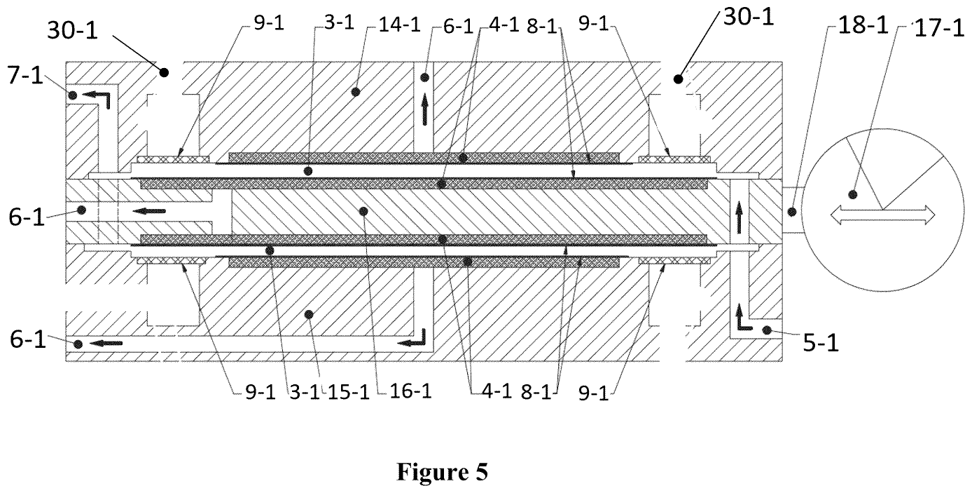

FIG. 6 shows an arrangement for connecting the flat filter modules to the vibration motor and providing vibrational motion.

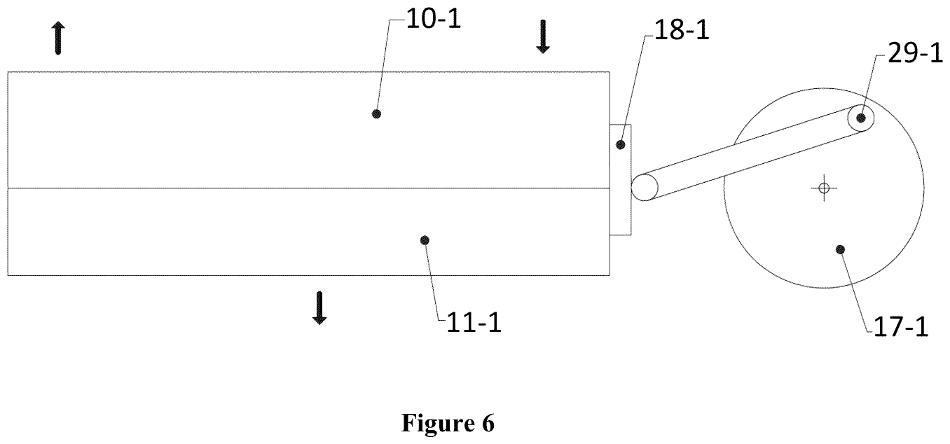

FIG. 7 shows an arrangement for connecting the flat filter modules to the vibration motor and providing vibrational motion.

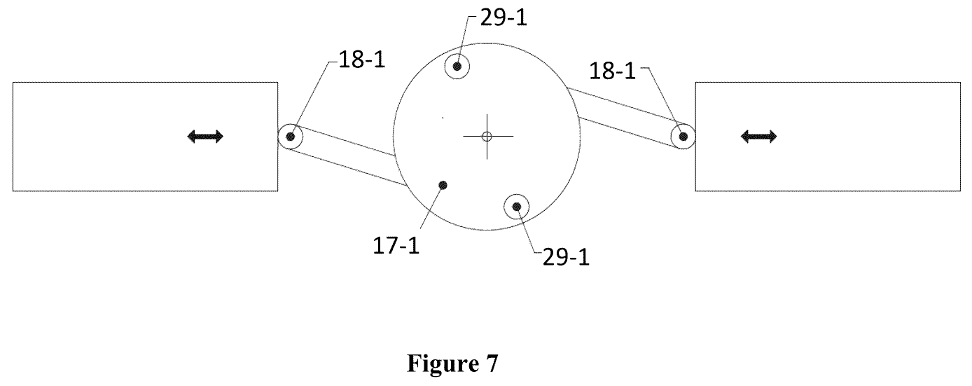

FIG. 8 shows a cross section of a first example of a tubular filter module.

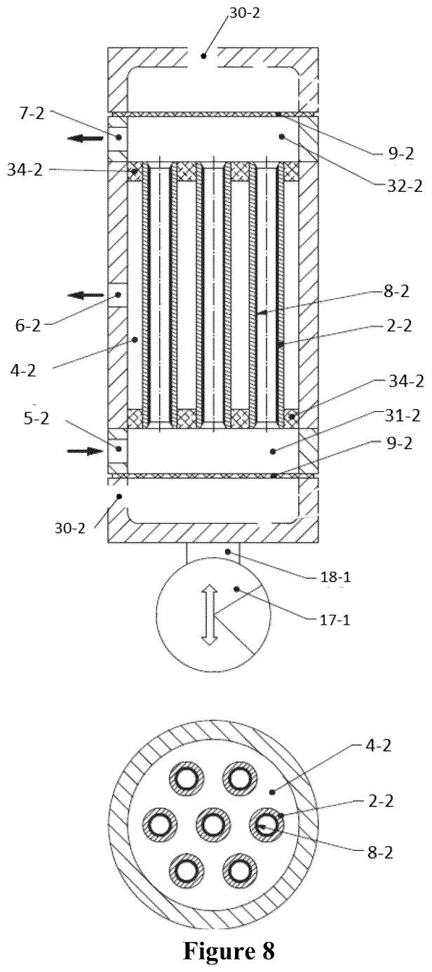

FIG. 9 shows a cross section of a second example of a tubular filter module.

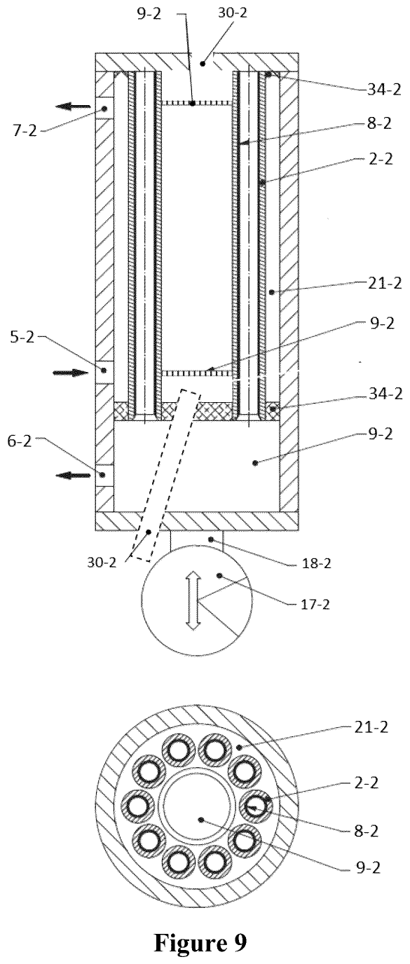

FIG. 10 shows an arrangement for connecting tubular filter modules to the vibration motor and providing vibrational motion.

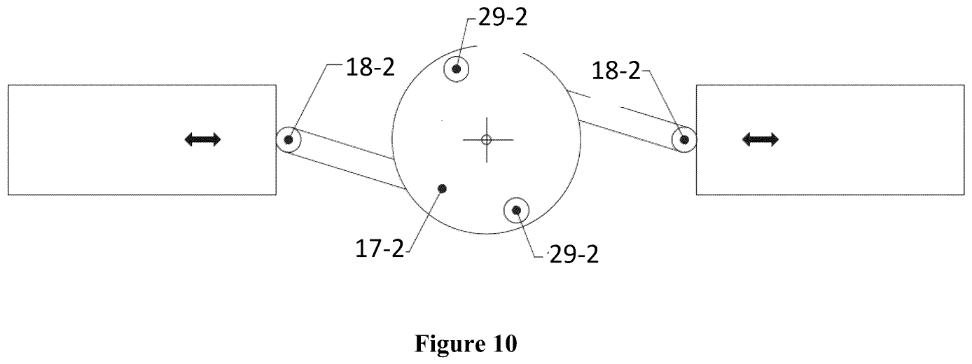

FIG. 11 shows an arrangement for connecting tubular filter modules to the vibration motor and providing vibrational motion.

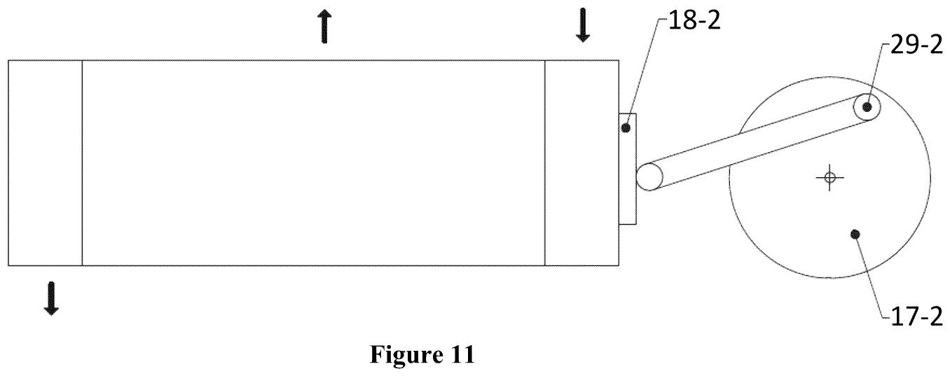

FIG. 12 shows a perspective view of a filter plate assembly filtration device.

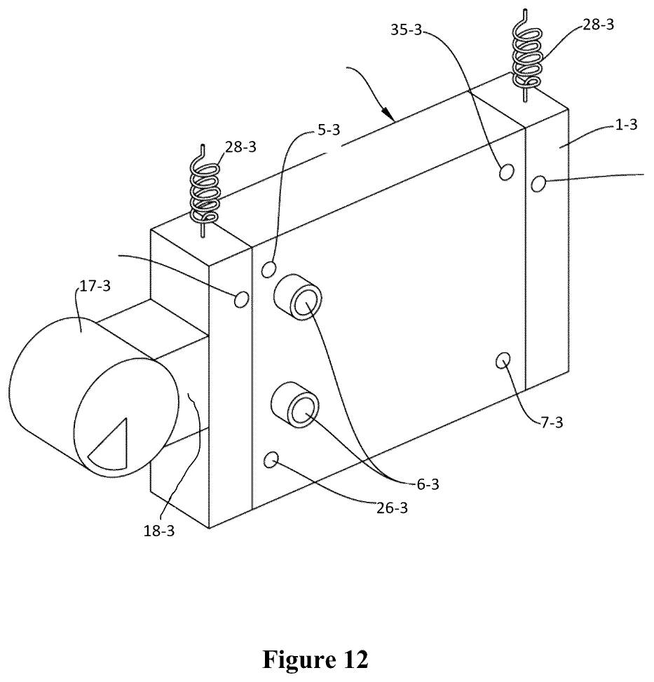

FIG. 13 shows a cross section of a filter plate assembly filtration device.

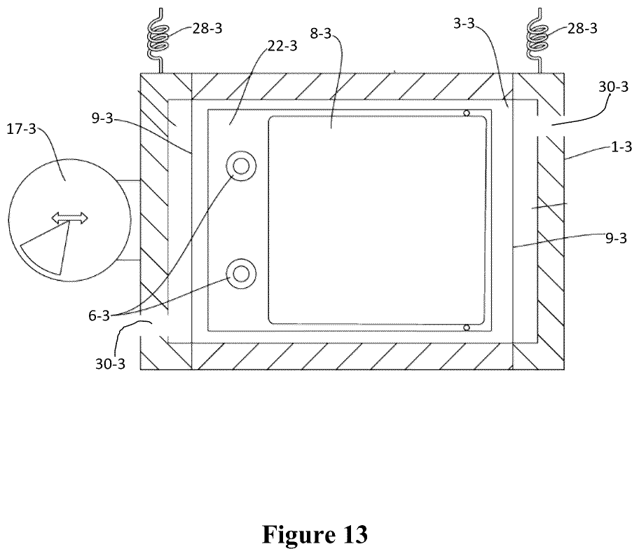

FIG. 14 shows a perspective view of multiple filter plates in a filter plate assembly.

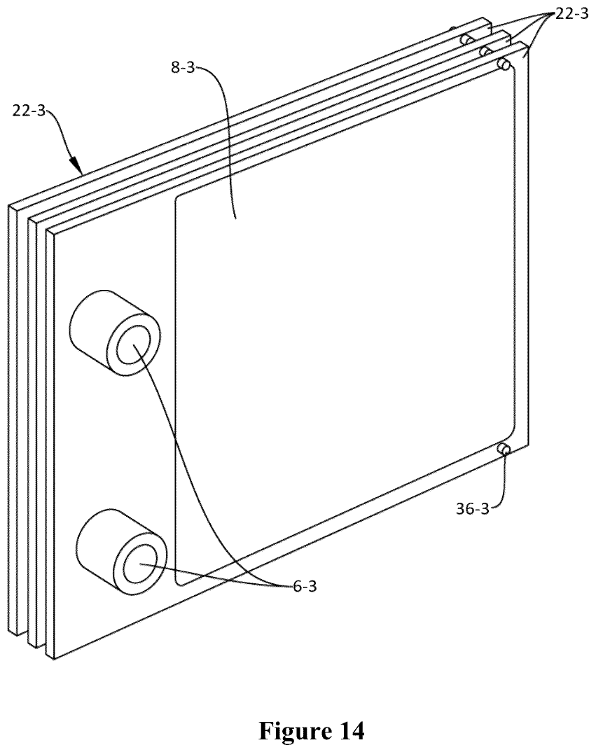

FIG. 15 shows a further perspective view of multiple filter plates in a filter plate assembly.

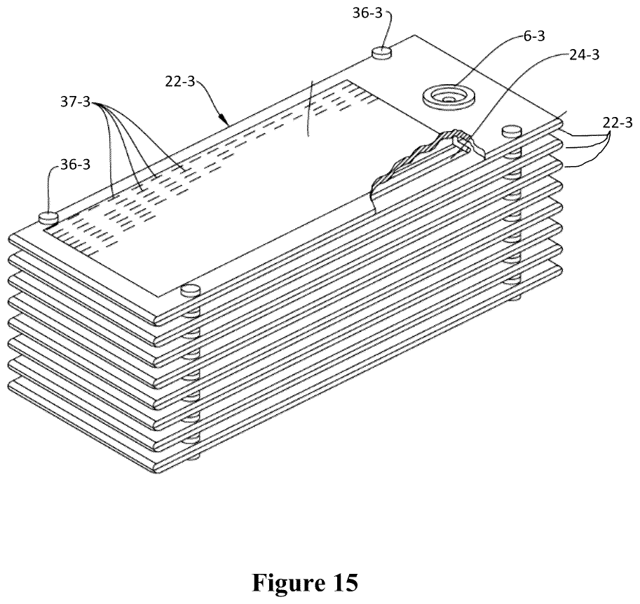

### INCORPORATION BY REFERENCE

All publications, patents, and patent applications referred to herein are incorporated by reference to the same extent as if each individual publication, patent, or patent application was specifically and individually indicated to be incorporated by reference. In the event of a conflict between a term herein and a term in an incorporated reference, the term herein prevails and controls.

### DETAILED DESCRIPTION

The features and advantages of the present invention is readily apparent to a person skilled in the art by the below detailed description of embodiments and examples of the invention with reference to the figures and drawings included herein.

The filtration device (1) described herein for low pressure vibration filtration of a liquid comprises one or more filter modules (2), each filter module comprising;

a volume chamber (3) comprising a feed inlet (5) for a liquid to be filtered and a retentate outlet (7);

a drainage chamber (4) fluidly connected to the volume chamber (3) and comprising a permeate outlet (6);

a semipermeable membrane (8) separating the volume chamber from the drainage chamber allowing one or more components of the liquid (permeate) to pass from the volume chamber to the drainage chamber while retaining one or more components of the liquid (retentate) in the volume chamber;

one or more flexible wall elements, (9), positioned distally in at least one end of the volume chamber, wherein the flexible wall element is impermeable to, but in contact with the liquid to be filtered on one side, and in contact with the external atmospheric environment on the other side, thereby separating the liquid from the external atmospheric environment; and

wherein the volume chamber and the semipermeable membrane are configured to allow the liquid in the volume chamber to move across the surface of the semipermeable membrane when the filter module is subjected to a vibrating motion; wherein the volume chamber and the flexible wall element are configured to extend or contract the flexible wall element determined by the pressure of the liquid on flexible wall element applied when the filter module is subjected to a vibrating motion.

In a special embodiment the filter module is as described in WO2022157133, incorporated herein by reference.

In one embodiment the volume chamber (3-1) of the filtration device is flat and formed between two or more parts (10 and 11), and the semipermeable membrane (8) is planar. More particularly in this embodiment
the filter module (2-1) comprises at least two fitting parts, part (10-1) and part (11-1) configured for edgewise bonding, together creating the flat volume chamber (3-1);
part (10-1) comprises in one end the feed inlet (5-1) and in the opposite end the retentate outlet (7-1);
part (10-1) further comprises at least two flexible wall elements (9) planar to the flat volume chamber and being spaced apart such as being positioned (distally) in each end of the volume chamber and proximal to the feed inlet (5-1) and the retentate outlet (7-1), respectively, whereby the flexibility of the wall elements allows the liquid to be filtered in the volume chamber (3-1) to move in parallel (back and forth) relative to the surface of the planar semipermeable membrane (8-1), when the filter module (2-1) is subjected to a vibrating motion;
part (11-1) comprises the permeate outlet (6-1) and the drainage chamber (4-1) and the planar semipermeable membrane (8-1) covers the drainage chamber (10-1) and is fluidly tight sealed between the drainage chamber (4-1) and the volume chamber (3-1); and
the filtration device further comprises a vibration motor (17-1) having a receptacle (18-1) for mounting said filter module (2-1), said vibration motor (17-1) being configured for providing a vibrating motion to the filter module (2-1).

In a further additional or alternative embodiment of the filtration device the filter module (2-1) comprises at least two fitting parts, part (12-1) and part (13-1) configured for edgewise bonding, together creating a flat volume chamber (3-1);
part (12-1) comprises in one end the feed inlet (5-1) and in the opposite end the retentate outlet (7-1) and in between the planar semipermeable membrane (8-1) and drainage chamber (4-1);
the planar semipermeable membrane surface (11-1) forms a side of the volume chamber and is positioned on top of the drainage chamber (4-1) positioned in a cavity of part (12-1) connecting to the permeate outlet (6-1);
the planar semipermeable membrane (8-1) is edge wise sealed and bonded to part (12-1);
part (13-1) comprises at least two flexible wall elements (9) planar to the flat volume chamber and being spaced apart such as being positioned distally in each end of the volume chamber, whereby the flexibility of the wall elements allows the liquid to be filtered in the volume chamber (3-1) to move in parallel (back and forth) relative to the surface of the planar semipermeable membrane (8-1), when the filter module (2-1) is subjected to a vibrating motion;
part (12-1) comprises the permeate outlet (6-1), the drainage chamber (4-1) and the planar semipermeable membrane (8-1) covering said drainage chamber (4-1) and being fluidly tight sealed between the drainage chamber (4-1) and the volume chamber (3-1); and
the filtration device further comprises a vibration motor (17-1) having a receptacle (18-1) for mounting said filter module (2-1), said vibration motor (17-1) being configured for providing a vibrating motion to the filter module (2-1).

In a still further additional or alternative embodiment of the filtration device the filter module (2-1) comprises at least 2 flat volume chambers (3-1) each one configured with one or more drainage chambers (4-1) and one or more planar semipermeable membranes (8-1) separating the volume chambers from the drainage chambers allowing one or more components of the liquid (permeate) to pass from the volume chamber to the drainage chamber while retaining one or more components of the liquid (retentate) in the volume chamber;
the filter module (2-1) comprises comprising 3 matching parts, part 14-1, part 15-1 and part 16-1; part 16-1 being positioned in between part 14-1 and part 15-1;
parts 14-1 and 15-1 each comprises a feed inlet (5-1), a retentate outlet (7-1), two flexible wall elements (9-1), a planar semipermeable membrane (8-1), a drainage chamber (4-1) and a permeate outlets (9-1);
part 16-1 comprises a feed inlet (5-1), a retentate outlet (7-1), two planar semipermeable membranes (8-1), two drainage chambers (10-1) and a permeate outlets (9-1);
the planar semipermeable membrane surface (11-1) forms a side of the volume chamber (3-1) and is positioned on top of the drainage chamber (4-1) connecting to the permeate drain (9-1);
the planar semipermeable membranes (8-1) are edge wise sealed and bonded to part 14-1, 15-1 and 16-1;
the flexible wall elements (9) are planar to the flat volume chamber and being spaced apart such as being positioned distally in each end of the volume chamber, whereby the flexibility of the wall elements allows the liquid to be filtered in the volume chamber (3-1) to move in parallel (back and forth) relative to the surface of the planar semipermeable membrane (8-1), when the filter module (2-1) is subjected to a vibrating motion;
planar semipermeable membranes (8-1) covering drainage chambers (10-1) are fluidly tight sealed between drainage chambers (10-1) and volume chambers (5-1); and
the filtration device further comprises a vibration motor (17-1) having a receptacle (18-1) for mounting said filter module (2-1), said vibration motor (17-1) being configured for providing a vibrating motion to the filter module (2-1).

Each of the flexible wall elements (9) further comprise a flexible gasket (19-1) sealing the flexible wall elements (9) to the volume chamber.

The filtration device employing flat volume chambers having at least two fitting and typically non-identical half parts forming a flat volume chamber provides for a simplified filter module construction with optimized free flow filtering capacity and being capable of maintaining a high flux in a continuous low pressure and vibration driven filtration process while having a wide range of scaling sizes for filtration of very small volumes of fluids as well as large volumes using the same general construction configuration. This simple construction is obtained using a limited number of components allowing the same construction configuration for a wide range of device sizes corresponding to feeds of very small volumes as well as much larger volume. The flexible wall elements are elastic and can accommodate movement of the liquid to be filtered caused by the vibrating motion and the inertia of the liquid thus allowing the liquid to be filtered to move in parallel (back and forth) relative to the surface of the semipermeable membrane. A further considerable advantage is that filtration data obtained for small test volumes using the filtration device of the invention can easily be extrapolated to much larger industrial type volumes using an up-scaled version of the filtration device. The filtration device having flat volume chambers is easy to handle and move around and can easily be fitted in with other process equipment.

In a special embodiment the filter module is as described in WO2022171615, incorporated herein by reference.

In an additional or alternative embodiment, the volume chamber (3-2), the drainage chamber (4-2) and the semipermeable membrane (8-2) are wholly or partially tubular (16-2).

More Particularly in this Embodiment
each of the tubular volume chamber (3-2) may be wholly or partially enclosed by the tubular semipermeable membrane which is wholly or partially enclosed by the drainage chamber (4-2);
at least two flexible wall elements (9-2) are positioned distally in each end of the one or more volume chambers;
the feed inlet (5-2) and the retentate outlet (7-2) are positioned distally at the end of the tubular volume chamber (3-2) and proximally to the two flexible wall elements (9-2); and
the filtration device further comprises a vibration motor (17-2) having a receptacle (18-2) for mounting said filter module (2-2), said vibration motor (17-2) being configured for providing a vibrating motion to the filter module (2-2). In this embodiment the filtration device can further comprise a retentate channel (21-2). Additionally, in this embodiment the filtration device can further comprise a positive-displacement pump, a centrifugal and an axial-flow pump pumping the permeate and or the retentate away from the filter module (2-2). A useful example of such a pump is a peristaltic pump. Additionally, in this embodiment each of the two flexible wall elements (9-2) can comprise a flexible gasket (19-2) sealing the two flexible wall elements (9-2) to the volume chamber. Additionally, in this embodiment the cross section of the volume chamber (3-2) and/or the drainage chamber (4-2) can be circular, ellipsoid, or polygonal, such as triangular, tetragonal, pentagonal or hexagonal and where the semipermeable membrane (8-2), is either inside or outside the tubular member.

The filtration device employing tubular volume chambers also provides for a simplified filter module construction with optimized free flow filtering capacity and being capable of maintaining a high flux in a continuous low pressure and vibration driven filtration process while having a wide range of scaling sizes for filtration of very small volumes of fluids as well as large volumes using the same general construction configuration. This simple construction is obtained using a limited number of components allowing the same construction configuration for a wide range of device sizes corresponding to feeds of very small volumes as well as much larger volume. The flexible wall elements are elastic and can accommodate movement of the liquid to be filtered caused by the vibrating motion and the inertia of the liquid thus allowing the liquid to be filtered to move in parallel (back and forth) relative to the surface of the semipermeable membrane. The filtration device employing tubular volume chambers is particularly useful for operations, such as fine filtration, microfiltration and ultrafiltration of liquids using a semipermeable membrane, where the membrane is typically subjected to a tangential flow of feed fluid. The filtration device having tubular volume chambers is further useful in operations where a robust and sanitary, fouling preventing continuous filtration is desirable, and the filtration device is capable of being configured to filtering operations of a wide range of fluid volumes, such as volumes as small as about 100 mL and being scalable to filter larger volumes, such as 100 m3. A further considerable advantage is that filtration data obtained for small test volumes using the filtration device of the invention can easily be extrapolated to much larger industrial type volumes using an up-scaled version of the filtration device. The filtration device having tubular volume chambers is easy to handle and move around and can easily be fitted in with other process equipment.

In a special embodiment the filter module is as described in WO2018145714, incorporated herein by reference.

In a still further additional or alternative embodiment the of filter module (2-3) comprises a filter-plate assembly (22-3) wherein the volume chamber (3-3) is configured for expanding and/or compressing the volume of the volume chamber (3-3) allowing liquid in the volume chamber to move across the surface of said filter-plates when the filter module is subjected to a vibrating motion. More particularly in this embodiment
the filter-plate assembly (22-3) comprises a plurality of rigid, planar filter plates (23-3) comprising one or more permeate channels (24-3) and one or more permeate exits (6-3);
the one or more permeate exits (6-3) extend perpendicular to the filter-plate assembly (22-3) and through the drainage chamber (4-3) configured for allowing for the permeate to exit the drainage chamber (4-3);
the filter-plate assembly (22-3) is rigidly mounted inside the filter module (2-3);
the volume chamber (3-3) comprises at least one feed inlet (5-3) configured for allowing a retentate stream to enter the volume chamber (3-3) and at least one retentate outlet (7-3) configured for allowing a retentate stream to exit the volume chamber (3-3);
the at least two flexible wall elements (9-3) are positioned distally in each end of the volume chamber (3-3) whereby the flexibility of the wall elements allows liquid to be filtered in the volume chamber (3-3) to move in parallel (back and forth) relative to the surface of the planar semipermeable membrane (8-3), when the filtration device (1-3) is subjected to a vibrating motion; and
the filtration device further comprises a vibration motor (17-3) having a receptacle (18-3) for mounting said filter module (2-3), said vibration motor (17-3) being configured for providing a vibrating motion to the filter module (2-3). In this embodiment the filter module can further comprise a through-hole ((25-3) providing for a passage of the one or more permeate exits (6-3) from the drainage chamber (4-3) through the volume chamber (3-3), where said through-hole (25-3) structurally fixes the filter plate assembly rigidly in the filter module (2-3) while allowing for drainage of permeate from the filter plate assembly (22-3) outside the filter module (2-3). In this embodiment the filtration device can comprise two or more filter modules (2-3) connected and structurally configured for balancing out vibrations and reduction of external vibration. Moreover, in special embodiments the filtration device of this embodiment can comprise at least one back-mix connection (26-3) for homogenization of the liquid to be filtered by leading the retentate from the back-mix connection (26-3) to another area (27-3) of the filter module (2-3) through connections (26-3). The filtration device can also comprise one or more flexible support or suspension elements (28-3), wherein the filter module (2-3) is supported by the at least one flexible support element (28-3) which allows vibrating motion of the filter module (2-3), and which preferably guides and/or controls the vibration motion. In some embodiments semipermeable membrane in the filter plate assembly can be made up of more than one membrane layers, such as particularly a double membrane layer for more effective filtering.

The filtration device employing a filter plate assembly also provides for a simplified filter module construction with optimized free flow filtering capacity and being capable of maintaining a high flux in a continuous low pressure and vibration driven filtration process. This construction if particularly suitable for filtration of larger volumes and have due to assembly structure a wide range of scaling sizes for filtration using the same general construction configuration. The construction employs a limited number of components allowing the same construction configuration for a wide range of device sizes corresponding to feeds of varying volumes. The flexible wall elements are elastic and can accommodate movement of the liquid to be filtered caused by the vibrating motion and the inertia of the liquid thus allowing the liquid to be filtered to move in parallel (back and forth) relative to the surface of the semipermeable membrane maintaining a turbulent layer between filter-plate surface and surrounding liquid through the relative movement between these, hereby obtaining a high permeate flux in the continuous filtration process. This construction provides for an energy efficient and cost-efficient device, where the energy efficiency is obtained through turbulence in the liquid to be filtered created directly at the filter-plate surface or semi permeable membrane surface, where the turbulence keeps the semipermeable membrane from clogging. Thus, energy consumption compared to a typical cross flow filtering device is greatly reduced. Using the filter plate assembly construction the liquid to be filtered is vibrated relative to the surface of the semipermeable membrane and can at the same time pass freely between the filter-plates so that free flow filtration is obtained, thereby allowing filtration of liquids which are highly viscous and even contain large particulate impurities, as long as the liquid does not block the free flow passage between plates. Optimal turbulence is created at the filter/membrane surface by the vibrating motion of the filter-plate assembly relative to the media to be filtered (feed, retentate). The vibrating motion enables low fouling operation and, thus, effective filtration without the need of fast cross-flow to create turbulence at the filter surface in conventional cross-flow filtration.

In some embodiments the vibration motor (17) is adapted to provide vibrating motion of a linear or circular nature or a combination of both. Particularly, the direction of the vibrating motion may essentially be perpendicular to the plane of the one or more flexible wall elements (9). The vibration motion can advantageously be transferred from the vibration motor (17) provides vibration motion to the filter module (2) through an eccentric axis (29) or through one or more rotating counterweights. Additionally or alternatively, the filtration device can comprise two or more filter modules (2), said two or more filter modules (2) being connected to one or more vibration motors. In a preferred embodiment the direction of the vibrating motion provided by the vibration motor is perpendicular to the plane of the flexible wall elements (9).

The flexible wall element (9) has in particular embodiments a surface area of between 2 to 2000 cm², such as from 2 to 25 cm², such as from 25 to 50 cm², such as from 50 to 100 cm², such as from 100 to 250 cm², such as from 250 to 500 cm², such as from 500 to 1000 cm², such as from 1000 to 1500 cm², such as from 1500 to 2000 cm².

In additional or alternative embodiments, the flexible wall element (9) has thickness of between 0.5 to 5 mm, such as between 0.1 to 1 mm, such as between 1 to 2 mm, such as between 2 to 3 mm, such as between 3 to 4 mm, such as between 4 to 5 mm. In a special embodiment the flexible wall element is made of EPDM (Ethylene Propylene Diene Monomer) rubber and has a dimension of 1×3 cm and a thickness of 1 mm, while in another embodiment the flexible wall element is made of EPDM rubber and has a dimension of 3.5×20 cm and a thickness of 2 mm.

In additional or alternative embodiments, the flexible wall element (9) has an elastic modulus similar to within +30% to natural or synthetic rubber, silicone, or EPDM. Moreover, the flexible wall element (9) can comprise one or more components selected from natural or synthetic rubber, silicone, or metal alloys.

The flexible wall element(s) (9) is preferably connected to the external atmospheric environment though one or more through-holes or channels (30) or open walls in the filter module.

Also described herein is a method for filtering a liquid and separating one or more components of the liquid (permeate) from one or more other components of the liquid (retentate) comprising feeding the liquid to the filtration device as described herein and applying vibrational motion to the filter module(s) comprised in the filtration device and collecting the separated retentate and permeate.

In some embodiments the inlet feed of liquid and vibrational motion is configured to maintain a pressure in the liquid of at most 1 bar, such as at most 0.5 bar, such as between −0.4 bar to 0.4 bar.

The filtration can be performed continuously or intermittently, where one part of the filtrated liquid is concentrated in the filter module (2) and the vibration action maintains the flux through the semipermeable membrane (8). Additionally or alternatively, the filtration can also be performed as a vibration driven dead-end filtration operation, where one part of the liquid is concentrated in the filter module (2) and discharged at the end of operations or intermittently. In a preferred embodiment the filtration is performed continuously.

In some embodiments a desired component is separated from an undesired component of the inlet feed and the desired component is discharged through the retentate outlet (7), while the undesired component is discharged trough the permeate outlet (6). In other embodiments the desired component is discharged through the permeate outlet (6), while the undesired component is discharged trough the retentate outlet (7).

The desired component is suitably a polypeptide such as an enzyme or a pharmaceutical ingredient, while the undesired component typically is a biological material, such as virus, or a microbial cell, such as bacteria or fungal cells or debris thereof.

### Working Examples

### Example 1—Low Pressure Vibration Filtration Using a Flat Filter Module

A 35 cm² filter assembly with a 0.2 micron PTFE membrane was mounted in the flow chamber of the filter module and the filter module was mounted in the vibration drive unit. The Vibro unit was checked for leaks with water at 0.8 bar. In either end of the volume chambers flow-path a 1 mm thick 2.8 cm² EPDM gasket defined the flexible wall in the rigid filter module, the outside of the flexible wall part being in contact with outside of filter module but sealingly mounted towards the retentate volume chamber.

As the filter had previously been CIP cleaned, a 10 min hot water wash was performed at 0.1 bar pressure and the vibration motor adjusted to 18 Hz and a slow flow running with partly opened retentate outlets. The unit was drained and flushed thoroughly with water. The unit was drained again, and water was used as the media in a dead-end filtration at 0.1 bar with the vibration motor at 18 Hz and closed retentate outlets. The average flux was measured after 10 min to 280 LMH over a 5 min period.

The unit was re drained and Rynkeby orange juice was used as the media in a dead-end filtration at 0.1 bar with the vibration motor at 18 Hz and closed retentate outlet. The time and permeate volume produced was registered at intervals and the average flux between the measuring points was calculated. The results are listed in Table 1.

TABLE 1

| Time (sec) | Permeate Flux* (LMH) |
|---|---|
| 0 | — |
| 40 | 40 |
| 80 | 40 |
| 140 | 39 |
| 200 | 39 |
| 260 | 39 |
| 360 | 39 |
| 420 | 39 |
| 480 | 38 |
| 540 | 36 |
| 600 | 36 |
| 660 | 35 |
| 720 | 35 |

*Average Flux between the last and the current measuring point

The unit was redrained, and hot water followed by caustic CIP cleaning was performed and original water flux was reobtained.

The unit was redrained and Rynkeby orange juice was used as the media in a dead-end filtration at 0.1 bar with the vibration motor stopped and closed retentate outlet. The time was registered at each 5 ml of permeate produced and the average flux between the measuring points was calculated. The results are listed in Table 2.

TABLE 2

| Time (sec) | Permeate Flux* (LMH) |
|---|---|
| 0 | — |
| 40 | 38 |
| 80 | 33 |
| 120 | 28 |
| 180 | 22 |
| 240 | 17 |
| 300 | 12 |
| 420 | 8 |
| 480 | 7 |
| 580 | 5 |
| 660 | 4 |

*Average Flux between the last and the current measuring point

The unit was redrained, and hot water followed by caustic CIP cleaning was performed and original water flux was reobtained.

Conclusion: Without vibration the flux declines very fast and an 18 Hz vibration with elastic flexible wall element made the orange juice filtration much faster and the filter module was seen to be performing as a larger module using the same membrane. The filter module performed en par with a similar test made against closed air cushioned filter modules of the art at the same trans membrane pressure of 0.1 bar.

### List of Numerals and References

(1), (1-1), (1-2), (1-3): Filtration device
(2), (2-1), (2-2), (2-3): Filter module
(3), (3-1), (3-2), (3-3): Volume chamber
(4), (4-1), (4-2), (4-3): Drainage chamber
(5), (5-1), (5-2), (5-3): Feed inlet
(6), (6-1), (6-2), (6-3): Permeate outlet
(7), (7-1), (7-2), (7-3): Retentate outlet
(8), (8-1), (8-2), (8-3): Semipermeable membrane
(9), (9-1), (9-2), (9-3): Flexible wall element
(10), (10-1), (10-2), (10-3): Module part I
(11), (11-1), (11-2), (11-3): Module part II
(12), (12-1), (12-2), (12-3): Module part III
(13), (13-1), (13-2), (13-3): Module part IV
(14), (14-1), (14-2), (14-3): Module part V
(15), (15-1), (15-2), (15-3): Module part VI
(16), (16-1), (16-2), (16-3): Module part VII
(17), (17-1), (17-2), (17-3): Vibration motor
(18), (18-1), (18-2), (18-3): Receptacle
(19), (19-1), (19-2), (19-3): Flexible gasket
(20), (20-1), (20-2), (20-3): Rigid walls
(21), (21-1), (21-2), (21-3): Retentate channel
(22), (22-1), (22-2), (22-3): Filter plate assembly
(23), (23-1), (23-2), (23-3): Planar filter plates
(24), (24-1), (24-2), (24-3): Permeate channel
(25), (25-1), (25-2), (25-3): Through-hole
(26), (26-1), (26-2), (26-3): Back-mix connection
(27), (27-1), (27-2), (27-3): Other filter module area
(28), (28-1), (28-2), (28-3): Support/suspension element
(29), (29-1), (29-2), (29-3): Eccentric axis
(30), (30-1), (30-2), (30-3): Exit or passage to atmosphere from the backside of the flexible wall
(31), (31-1), (31-2), (31-3): Inlet chamber
(32), (32-1), (32-2), (32-3): Retentate outlet chamber
(33), (33-1), (33-2), (33-3): Permeate collection chamber
(34), (34-1), (34-2), (34-3): Sealing and fixing potting
(35), (35-1), (35-2), (35-3): De-aeration passage
(36), (36-1), (36-2), (36-3): Bonding points
(37), (37-1), (37-2), (37-3): Plate perforations

1. A filtration device (1) for low pressure vibration filtration of a liquid comprising one or more filter modules (2), each filter module comprising;
a) a volume chamber (3) comprising a feed inlet (5) for a liquid to be filtered and a retentate outlet (7);
b) a drainage chamber (4) fluidly connected to the volume chamber (3) and comprising a permeate outlet (6);
c) a semipermeable membrane (8) separating the volume chamber from the drainage chamber allowing one or more components of the liquid (permeate) to pass from the volume chamber (3) to the drainage chamber while retaining one or more components of the liquid (retentate) in the volume chamber (3);
d) one or more flexible wall elements (9), positioned distally in at least one end of the volume chamber (3), wherein the flexible wall element is impermeable to, but in contact with the liquid to be filtered on one side, and in contact with the external atmospheric environment on the other side, thereby separating the liquid from the external atmospheric environment;
wherein the volume chamber (3) and the semipermeable membrane are configured to allow the liquid in the volume chamber (3) to move across the surface of the semipermeable membrane when the filter module (2) is subjected to a vibrating motion; wherein the volume chamber (3) and the flexible wall element are configured to extend or contract the flexible wall element determined by the pressure of the liquid on flexible wall element applied when the filter module is subjected to a vibrating motion; and wherein the filtration device further comprises a vibration motor (17) having a receptacle (18) for mounting the filter module (2), the vibration motor (17) being configured for providing a vibrating motion to the filter module (2).

2. The filtration device of claim 1 wherein the volume chamber (3-1) is flat and formed between 2 or more fitting module parts (10 and 11), and the semipermeable membrane (8) is planar.

3. The filtration device of claim 2 wherein
a) the filter module (2-1) comprises at least two fitting parts, part (10-1) and part (11-1) configured for edgewise bonding, together creating the flat volume chamber (3-1);
b) part (10-1) comprises in one end the feed inlet (5-1) and in the opposite end the retentate outlet (7-1);
c) part (10-1) further comprises at least two flexible wall elements (9) planar to the flat volume chamber (3-1) and being spaced apart such as being positioned (distally) in each end of the volume chamber (3-1) and proximal to the feed inlet (5-1) and the retentate outlet (7-1), respectively, whereby the flexibility of the wall elements allows the liquid to be filtered in the volume chamber (3-1) to move in parallel (back and forth) relative to the surface of the planar semipermeable membrane (8-1), when the filter module (2-1) is subjected to a vibrating motion; and
d) part (11-1) comprises the permeate outlet (6-1) and the drainage chamber (4-1) and the planar semipermeable membrane (8-1) covers the drainage chamber (10-1) and is fluidly tight sealed between the drainage chamber (4-1) and the volume chamber (3-1).

4. The filtration device of claim 1 wherein
a) the filter module (2-1) comprises at least two fitting parts, part (12-1) and part (13-1) configured for edgewise bonding, together creating a flat volume chamber (3-1),
b) part (12-1) comprises in one end the feed inlet (5-1) and in the opposite end the retentate outlet (7-1) and in between the planar semipermeable membrane (8-1) and drainage chamber (4-1);
c) the planar semipermeable membrane surface (11-1) forms a side of the volume chamber and is positioned on top of the drainage chamber (4-1) positioned in a cavity of part (12-1) connecting to the permeate outlet (6-1);
d) the planar semipermeable membrane (8-1) is edge wise sealed and bonded to part (12-1);
e) part (13-1) comprises at least two flexible wall elements (9) planar to the flat volume chamber and being spaced apart such as being positioned distally in each end of the volume chamber, whereby the flexibility of the wall elements allows the liquid to be filtered in the volume chamber (3-1) to move in parallel (back and forth) relative to the surface of the planar semipermeable membrane (8-1), when the filter module (2-1) is subjected to a vibrating motion; and
f) part (12-1) comprises the permeate outlet (6-1), the drainage chamber (4-1) and the planar semipermeable membrane (8-1) covering said drainage chamber (4-1) and being fluidly tight sealed between the drainage chamber (4-1) and the volume chamber (3-1).

5. The filtration device of claim 1 wherein
a) the filter module (2-1) comprises at least 2 flat volume chambers (3-1) each one configured with one or more drainage chambers (10-1) and one or more planar semipermeable membranes (8-1) separating the volume chambers from the drainage chambers allowing one or more components of the liquid (permeate) to pass from the volume chamber to the drainage chamber while retaining one or more components of the liquid (retentate) in the volume chamber;
b) the filter module (2-1) comprises comprising 3 matching parts, part 14-1, part 15-1 and part 18-1; part 18-1 being positioned in between part 14-1 and part 15-1;
c) parts 14-1 and 15-1 each comprises a feed inlet (5-1), a retentate outlet (7-1), two flexible wall elements (9-1), a planar semipermeable membrane (8-1), a drainage chamber (4-1) and a permeate outlets (9-1);
d) part 16-1 comprises comprises a feed inlet (5-1), a retentate outlet (7-1), two planar semipermeable membranes (8-1), two drainage chambers (10-1) and a permeate outlets (9-1);
e) the planar semipermeable membrane surface (11-1) forms a side of the volume chamber (3-1) and is positioned on top of the drainage chamber (4-1) connecting to the permeate drain (9-1);
f) the planar semipermeable membranes (8-1) are edge wise sealed and bonded to part 14-1, 15-1 and 18-1;
g) the flexible wall elements (9-1) are planar to the flat volume chamber and being spaced apart such as being positioned distally in each end of the volume chamber, whereby the flexibility of the wall elements allows the liquid to be filtered in the volume chamber (3-1) to move in parallel (back and forth) relative to the surface of the planar semipermeable membrane (8-1), when the filter module (2-1) is subjected to a vibrating motion; and
h) planar semipermeable membranes (8-1) covering drainage chambers (10-1) are fluidly tight sealed between drainage chambers (10-1) and volume chambers (3-1).

6. The filtration device of claims 1 to 5, wherein each of the two flexible wall elements (9-1) comprise a flexible gasket (19-1) sealing the two flexible wall elements (9-1) to the volume chamber, the remaining walls (20-1) of the volume chamber being rigid.

7. The filtration device of claim 1 wherein the volume chamber (3-2), the drainage chamber (4-2) and the semipermeable membrane (8-2) are wholly or partially tubular.

8. The filtration device of claim 1 or 7 wherein
a) each of the tubular volume chamber (3-2) is wholly or partially enclosed by the tubular semipermeable membrane which is wholly or partially enclosed by the drainage chamber (4-2);
b) at least two flexible wall elements (9-2) are positioned distally in each end of the one or more volume chambers; and
c) the feed inlet (5-2) and the retentate outlet (7-2) are positioned distally at the end of the tubular volume chamber (3-2) and proximally to the two flexible wall elements (9-2).

9. The filtration device of claim 1 or 7 to 8 further comprising a retentate channel (21-2).

10. The filtration device of claim 1 or 7 to 9 further comprising a positive-displacement pump, a centrifugal or an axial-flow pump pumping the permeate and or the retentate away from the filter module (2-2).

11. The filtration device of claim 10 wherein the positive-displacement pump is a peristaltic pump.

12. The filtration device of claim 1 or 7 to 9 wherein each of the two flexible wall elements (9-2) comprise a flexible gasket (19-2) sealing the two flexible wall elements (9-2) to the volume chamber, the remaining walls (20-2) of the volume chamber being rigid.

13. The filtration device of claim 1 or 7 to 12 wherein a cross section of the volume chamber (3-2) and/or the drainage chamber (4-2) is circular, eplisoid, or polygonal, such as triangular, tetragonal, pentagonal or hexagonal and where the semipermeable membrane (8-2) is either inside or outside the tubular member.

14. The filtration device of claim 1 wherein the filter module (2-3) comprises a filter-plate assembly (22-3) where the volume chamber (3-3) is configured for expanding and/or compressing the volume of the volume chamber (3-3) allowing liquid in the volume chamber to move across the surface of said filter-plates when the filter module is subjected to a vibrating motion.

15. The filtration device of claim 14
a) wherein the filter-plate assembly (22-3) comprises a plurality of rigid, planar filter plates (23-3) comprising one or more permeate channels (24-3) and one or more permeate exits (6-3);
b) wherein the one or more permeate exits (6-3) extend perpendicular to the filter-plate assembly (22-3) and through the drainage chamber (4-3) configured for allowing for the permeate to exit the drainage chamber (4-3);
c) wherein the filter-plate assembly (22-3) is rigidly mounted inside the filter module (2-3);
d) wherein the volume chamber (3-3) comprises at least one feed inlet (5-3) configured for allowing a retentate stream to enter the volume chamber (3-3) and at least one retentate outlet (7-3) configured for allowing a retentate stream to exit the volume chamber (3-3); and
e) wherein at least two flexible wall elements ((9-3) are positioned distally in each end of the volume chamber (3-3) whereby the flexibility of the wall elements allows liquid to be filtered in the volume chamber (3-3) to move in parallel (back and forth) relative to the surface of the planar semipermeable membrane (8-3), when the filter module (2-3) is subjected to a vibrating motion.

16. The filtration device of claims 14 to 15 wherein the filter module (2-3) comprises a through-hole (25-3) adapted for a passage of the one or more permeate exits (6-3) from the drainage chamber (4-3) through the volume chamber (3-3), where said through-hole structurally fixes the filter plate assembly rigidly in the filter module (2-3) while allowing for drainage of permeate from the filter plate assembly (22-3) outside the filter module (2-3).

17. The filtration device of claims 14 to 16 comprising two or more filter modules (2-3) connected and structurally configured for balancing out vibrations and reduction of external vibration.

18. The filtration device of claims 14 to 21 further comprising at least one back-mix connection (26-3) for homogenization of the liquid to be filtered by leading the retentate from the back-mix connection (26-3) to another area (27-3) of the filter module (2-3) through connections (26-3).

19. The filtration device of claims 14 to 18 further comprising at least one flexible support or suspension element (28-3), wherein the filter module (2-3) is supported by the at least one flexible support element (28-3) and allows vibrating motion of the filter module (2-3), and wherein optionally the at least one flexible support (6-3) guides the vibration motion.

20. The filtration device of claims 14 to 19 wherein the semipermeable membrane (8-3) separating the volume chamber (3-3) from the drainage chamber (4-3) comprise two membrane layers.

21. The filtration device of any preceding claim wherein the vibration motor (17) is adapted to provide vibrating motion of a linear or circular nature or a combination of both.

22. The filtration device of any preceding claim wherein the direction of the vibrating motion is essentially perpendicular to the plane of the one or more flexible wall elements, (9).

23. The filtration device of any preceding claim, where said vibration motor (17) provides vibration motion to said filter module (2) through an eccentric axis (29) or through one or more rotating counterweights.

24. The filtration device of any preceding claim, comprising two or more filter modules (2), said two or more filter modules (2) being connected to one or more vibration motors.

25. The filtration device of any preceding claim wherein the direction of the vibrating motion is perpendicular to the plane of the flexible wall elements (9).

26. The filtration device of any preceding claim wherein the flexible wall element (9) has a surface area of between 2 to 2000 cm².

27. The filtration device of any preceding claim wherein the flexible wall element (9) has thickness of between 0.1 to 5 mm.

28. The filtration device of any preceding claim wherein the flexible wall element (9) has an elastic modulus similar within +30% to natural or synthetic rubber, silicone or EPDM.

29. The filtration device of any preceding claim wherein the flexible wall element (9) comprises one or more components selected from natural or synthetic rubber, silicone, or metal alloys

30. The filtration device of any preceding claim wherein the flexible wall element(s) (9) is connected to the external atmospheric environment though one or more through-holes or channels (30) in the filter module or open walls in the filter module.

31. A method for filtering a liquid and separating one or more components of the liquid (permeate) from one or more other components of the liquid (retentate) comprising feeding the liquid to a filtration device of claims 1 to 29 and applying vibrational motion to the filter modul(es) comprised in the filtration device and collecting the separated rententate and permeate.

32. The method of claim 31 wherein the inlet feed and vibrational motion is configured to maintain a pressure in the liquid of at most 0.5 bar, optionally between −0.4 bar and 0.4 bar.

33. The method of claims 31 to 32 wherein the filtration is performed continuously or intermittently, where one part of the filtrated liquid is concentrated in the filter module (2) and the vibration action maintains the flux through the semipermeable membrane (8).

34. The method of claims 31 to 32 wherein the filtration is performed as a vibration driven dead-end filtration operation, where one part of the liquid is concentrated in the filter module (2) and discharged at the end of operations or intermittently.

35. The method of claims 31 to 32 wherein the filtration is performed continuously.

36. The method of claims 31 to 35 wherein a desired component is separated from an undesired component of the inlet feed and wherein the desired component is discharged through the retentate outlet (7), while the undesired component is discharged trough the permeate outlet (6).

37. The method of claims 31 to 35 wherein a desired component is separated from an undesired component of the inlet feed and wherein the desired component is discharged through the permeate outlet (6), while the undesired component is discharged trough the retentate outlet (7).

38. The method of claims 36 to 37 wherein the desired component is a polypeptide such as an enzyme or a pharmaceutical ingredient.

39. The method of claims 36 to 37 wherein the undesired component is selected from biological materials, such as vira, bacterial or fungal cells or debris thereof.
